(19) United States
(12) Patent Application Publication
(10) Pub. No.: US 2007/0044769 A1
(43) Pub. Date: Mar. 1, 2007

(54) Control circuit for injectors having cut solenoids for LPI engines and cut solenoid control method and diagnostic method thereof

(75) Inventor: Deok-Ryol Kim, Yongin-si (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/297,835

(22) Filed: Dec. 7, 2005

(30) Foreign Application Priority Data
Aug. 30, 2005 (KR) 10-2005-0080175

(51) Int. Cl. F02M 51/00; F02D 17/04; F02D 7/00

(52) U.S. Cl. 123/479; 123/490; 123/198 DB; 123/481

(57) ABSTRACT

The present invention provides a control circuit for an injector having a cut solenoid for an LPI engine, a control method of the cut solenoid and a diagnostic method thereof. The present invention effectively prevents fuel from leaking through an injector to the atmosphere when the LPI engine stops, thus preventing air pollution, and satisfying a variety of relevant regulations.

### CROSS-REFERENCE TO RELATED APPLICATIONS

The present application is based on, and claims priority from, Korean Application Serial Number 10-2005-0080175, filed on Aug. 30, 2005, the disclosure of which is hereby incorporated by reference herein in its entirety.

### FIELD OF THE INVENTION

The present invention relates to LPI (liquefied petroleum gas injection) engines and, more particularly, to a control circuit of an injector having a cut solenoid for an LPI engine, a control method of the cut solenoid and a diagnostic method thereof.

### BACKGROUND OF THE INVENTION

Generally, in an LPI engine, if fuel, which has been supplied to an injector, still remains in a fuel line even after the engine stops, there is a likelihood of leakage of the liquefied fuel, having a property of being easily evaporated, outside of the engine. Particularly, there is a high possibility of leakage of the fuel through the injector.

Therefore, to prevent fuel from leaking through the injector when the engine is not running, an injector 502 seen in FIG. 1, having a cut solenoid 500, has been used.

As shown in the drawing, the conventional injector 502 with the cut solenoid 500 includes an injector part 504 which is provided at an upper position and has the same structure as that of an injector of prior arts, and a cut solenoid part 506 which is provided at a lower position and has a valve mechanism to be operated by the cut solenoid 500. Only when power is applied to the cut solenoid 500 can fuel be injected from the injector part 504 into the engine through the cut solenoid part 506.

### SUMMARY OF THE INVENTION

Embodiments of the present invention provide a control circuit for an injector having a cut solenoid for an LPI engine, a control method of the cut solenoid and a diagnostic method thereof.

A control circuit for injectors having cut solenoids for an LPI engine according to an embodiment of the present invention includes cut solenoids which are provided in the respective injectors. A power supply is connected to each of the cut solenoids. An electronic control unit controls the cut solenoids. Control lines connect the electronic control unit to the respective cut solenoids.

A method for controlling a cut solenoid of an injector for an LPI engine according to an embodiment of the present invention includes the step of determining whether a vehicle is in an ignition ON state, in which an ignition key is at an ON position or a START position. When the vehicle is in the ignition ON state, power is supplied to the cut solenoid provided in the injector, such that a cut solenoid part of the injector is opened. A malfunction of a cut solenoid related circuit is diagnosed through repeating a step of determining whether there is a malfunction of the cut solenoid related circuit, by comparing the ignition ON state with a power supply state of the cut solenoid until the vehicle enters an ignition OFF state from the ignition ON state, and a step of storing a diagnostic trouble code when there is a malfunction of the cut solenoid related circuit. The power of the cut solenoid is interrupted when the vehicle is in the ignition OFF state, such that the cut solenoid part of the injector is closed.

A method for diagnosing a cut solenoid of an injector of an LPI engine according to an embodiment of the present invention includes the step of determining whether a current, applied to the cut solenoid provided in the injector, flows in a phase equal to a phase of both an ignition ON state, in which an ignition key is at an ON position or a START position, and an ignition OFF state, in which the ignition key is at other positions. It is determined that a cut solenoid related circuit is in a normal state when the phases are equal to each other. It is determined that the cut solenoid related circuit is in a malfunctioning state when the phases are different from each other.

### BRIEF DESCRIPTION OF THE DRAWINGS

For a better understanding of the nature and objects of the present invention, reference should be made to the following detailed description with the accompanying drawings, in which:

FIG. 1 is a view showing the construction of an injector having a cut solenoid applied to the present invention;

FIG. 2 is a circuit diagram of a control circuit for injectors having cut solenoids of an LPI engine according to the present invention;

FIG. 3 is a circuit diagram showing a circuit, which is provided in an electronic control unit of FIG. 2 to control each cut solenoid;

FIG. 4 illustrates the operation of the circuit of FIG. 3;

FIG. 5 is a flowchart of a cut solenoid control method according to the present invention; and

FIG. 6 is a view illustrating a cut solenoid diagnostic method according to the present invention.

### DETAILED DESCRIPTION OF THE PREFERRED EMBODIMENTS

Hereinafter, a preferred embodiment of the present invention will be described in detail with reference to the attached drawings.

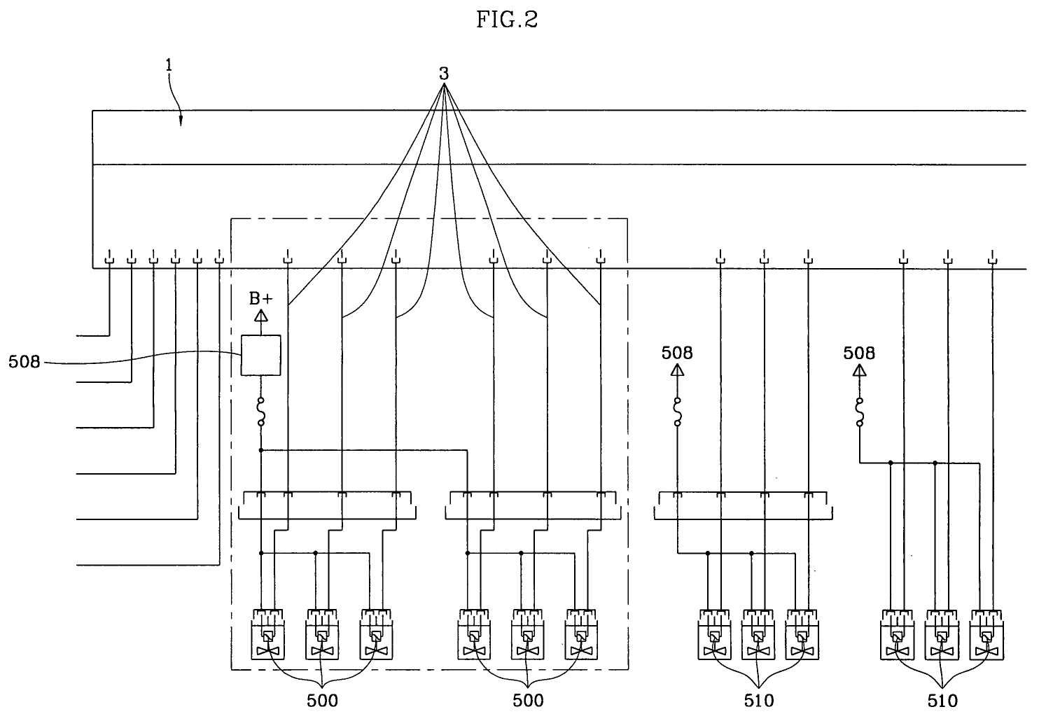

Referring to FIG. 2, a control circuit for injectors having cut solenoids for LPI engines according to the preferred embodiment of the present invention includes cut solenoids 500 which are provided in the respective injectors 502, a power supply connected in common to the cut solenoids 500, an electronic control unit 1 which controls the cut solenoids 500, and control lines 3 which connect the electronic control unit 1 to the respective cut solenoids 500.

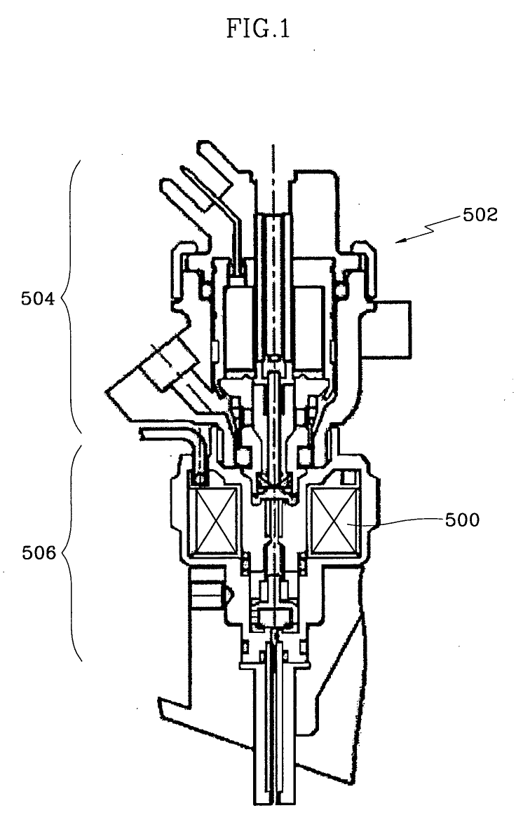

As shown in FIG. 1, each of the injectors 502 includes an injector part 504 and a cut solenoid part 506 therein. The electronic control unit 1 is connected to the injector parts 504 of the injectors 502 to be controlled.

In other words, the electronic control unit 1 controls both the injector parts 504 and the cut solenoid parts 506 of the injectors 502.

The power supply, which is connected in common to the cut solenoids 500, feeds power to the cut solenoids 500 through a fuel pump relay 508 provided to feed power to a fuel pump. Furthermore, this embodiment is constructed such that solenoids 510 of the injector parts 504 as well as the cut solenoids 500 are supplied with power through the fuel pump relay 508.

For reference, in FIG. 2, the arrows of wires, which are connected to the solenoids 510 of the injector parts 504, and the numerals 508 indicated by the arrows mean that the wires are connected to the fuel pump relay 508.

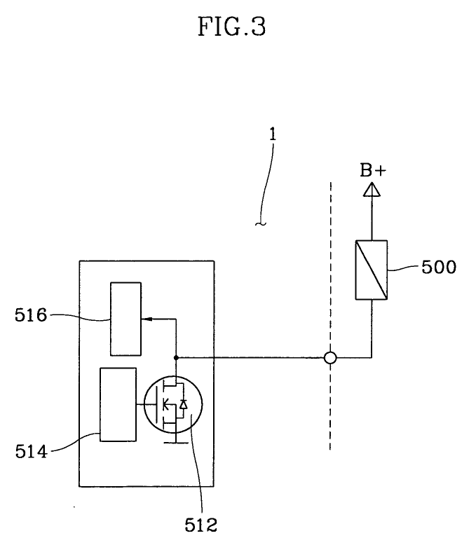

Meanwhile, as shown in FIG. 3, the electronic control unit 1 includes a transistor 512 which switches the power of each cut solenoid 500 which is an object to be controlled, a drive circuit 514 which supplies a base current to the transistor 512, and a diagnostic circuit 516 which compares the power supply state of the cut solenoid 500 to the state of the engine and thus diagnoses a malfunction of a cut solenoid related circuit.

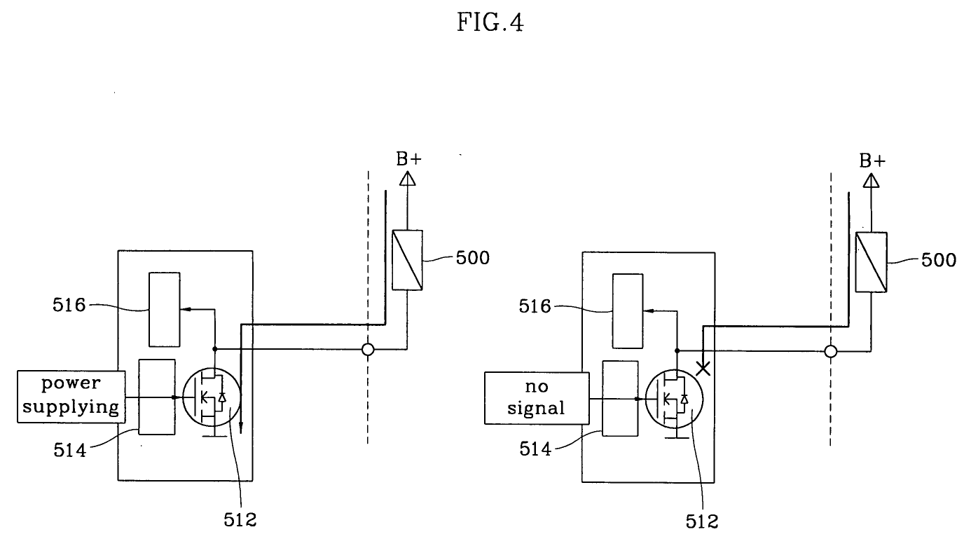

The operation of the electronic control unit 1 for driving the cut solenoid 500 is as follows, with reference to FIG. 4. In the left view of FIG. 4, the drive circuit 514 of the electronic control unit 1 applies base current to the base of the transistor 512, so that the cut solenoid 500 is grounded by the switching operation of the transistor 512. Then, current can flow from the fuel pump relay 508 to the cut solenoid 500.

In this state, a valve constituting the cut solenoid part 506 is opened by magnetization of the cut solenoid 500, so that fuel transferred from the injector part 504 can be supplied at any time into the engine.

In the right view of FIG. 4, the drive circuit 514 of the electronic control unit 1 interrupts the base current of the transistor 512, so that the transistor 512 acts as a nonconductor, that is, as a resistor having infinite resistance. Thus, current does not flow through the cut solenoid 500.

Then, the cut solenoid 500 is demagnetized, so that the valve constituting the cut solenoid part 506 is closed. In this state, fuel cannot be supplied from the injector part 504 into the engine.

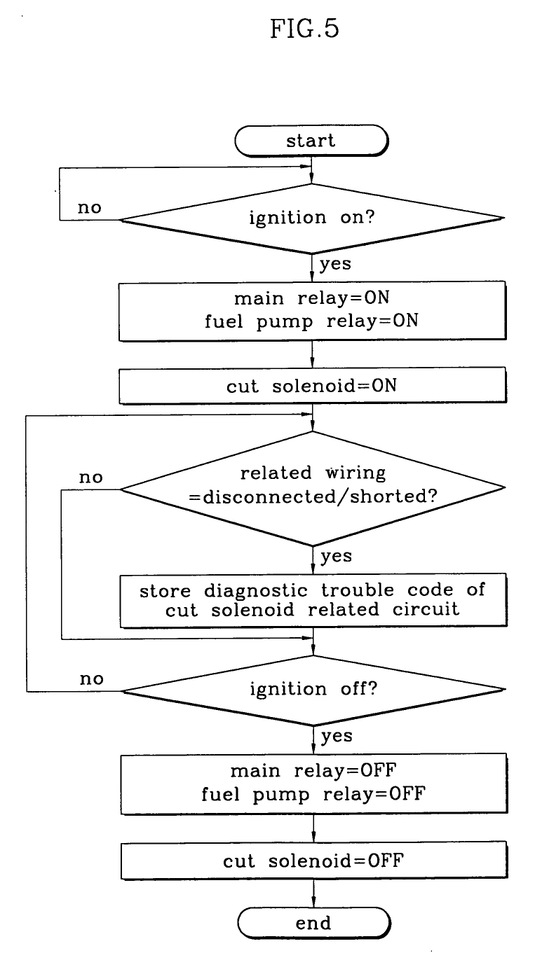

Hereinafter, a method for controlling a cut solenoid 500 of an injector 502 of the LPI engine according to the present invention will be described herein below with reference to FIG. 5.

As shown in FIG. 5, the cut solenoid control method of the present invention includes the steps of determining whether a vehicle is in an ignition ON state in which an ignition key is at an ON position, or a START position; supplying power to the cut solenoid 500 provided in the injector when the vehicle is in the ignition ON state, such that the cut solenoid part 506 of the injector is opened; diagnosing a malfunction of a cut solenoid related circuit through repeating the step of determining whether there is a malfunction of the cut solenoid related circuit, by comparing the ignition ON state with a power supply state of the cut solenoid 500 until the vehicle enters an ignition OFF state from the ignition ON state, and the step of storing a diagnostic trouble code when there is a malfunction in the cut solenoid related circuit; and interrupting the power of the cut solenoid 500 when the vehicle is in the ignition OFF state, such that the cut solenoid part 506 of the injector is closed.

In this embodiment, the cut solenoid control method further includes the step of turning on a main relay and a fuel pump relay 508 between the step of determining whether the vehicle is in the ignition ON state and the step of supplying the power to the cut solenoid 500.

Furthermore, the cut solenoid control method further includes the step of turning off the main relay and the fuel pump relay 508 between the diagnosing step of detecting a malfunction until the vehicle enters the ignition OFF state and the step of interrupting the power of the cut solenoid 500.

The electronic control unit 1 takes the case, in which a driver rotates the ignition key at the START position or maintains it at the ON position, as the ignition ON state, and takes the case, in which the ignition key is at other positions, as the ignition OFF state.

When a first ignition ON state occurs, another separate electronic control unit (not shown), which performs overall control of the engine along with the electronic control unit 1, sets the main relay, which supplies power to various electronic elements related to the engine, and the fuel pump relay 508, which supplies power the fuel pump to drive the fuel pump, to ON states.

Thereafter, the electronic control unit 1 applies a base current to the transistor 512 to supply power to the cut solenoid 500 of the injector, thus grounding the cut solenoid such that current flows through the cut solenoid 500.

In this state, the cut solenoid part 506 allows fuel to be supplied at any time into the engine from the injector part 504, and this state is maintained during the operational state of the engine.

While maintaining the above-mentioned state, the electronic control unit 1 repeatedly performs the diagnosing step until the vehicle enter the ignition OFF state, thus diagnosing a malfunction and disconnection of the circuit related to the cut solenoid part 506.

The diagnostic method will be explained in detail later herein.

When the ignition OFF state occurs, the separate electronic control unit, which governs the overall control of the engine, turns off the main relay and the fuel pump relay 508. Subsequently, the electronic control unit I interrupts the supply of the base current to the transistor 512 to interrupt the supply of the current to the cut solenoid 500, thus preventing fuel from leaking through the injector 502.

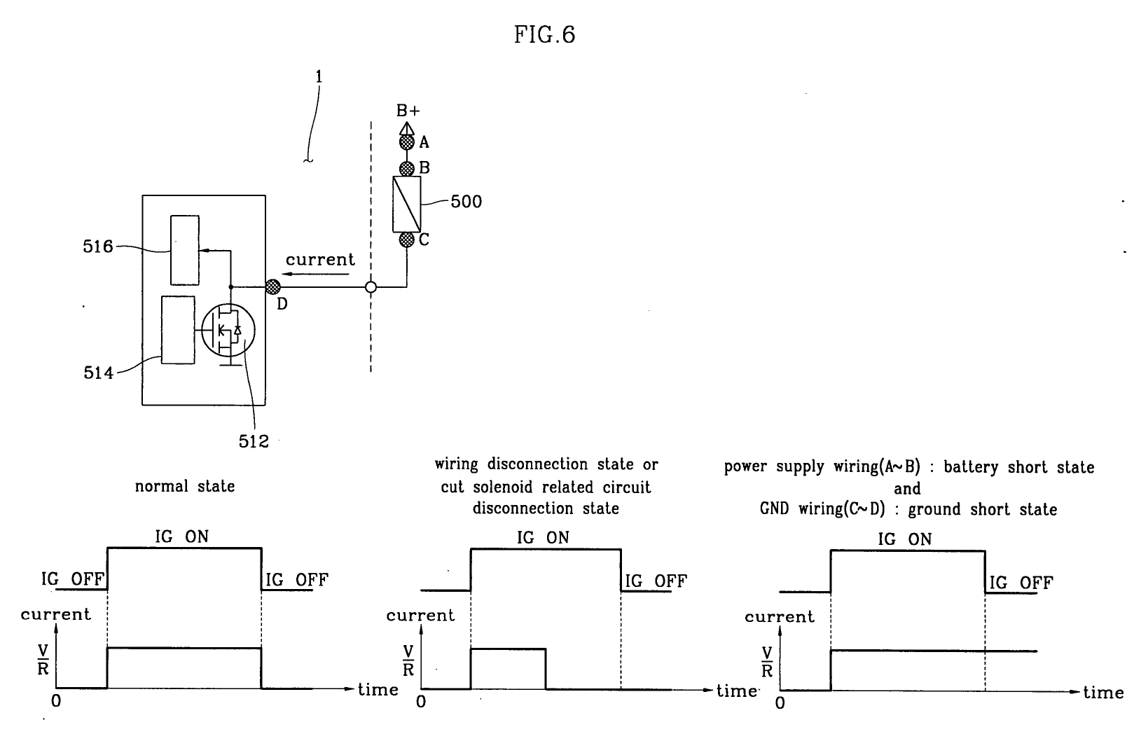

The method for diagnosing a cut solenoid 500 of an injector 502 of the LPI engine will be explained herein below with reference to FIG. 6.

The diagnostic method includes the step of determining whether current, applied to the cut solenoid 500 provided in the injector 502, flows in a phase equal to a phase of both the ignition ON state, in which the ignition key is at the ON position or the START position, and the ignition OFF state, in which the ignition key is at other positions. When the phases are equal to each other, it is determined that a cut solenoid related circuit is in a normal state. When the phases are different from each other, it is determined that the cut solenoid related circuit is in a malfunctioning state.

The diagnostic circuit 516 of the electronic control unit 1 determines the flow state of current applied to the cut solenoid 500 by detecting whether current flows through a control line 3 which electrically connects the cut solenoid 500 to the transistor 512.

The diagnostic circuit 516 simultaneously detects the ignition ON state and the ignition OFF state and determines whether the flow state of the current applied to the cut solenoid 500 varies to correspond to variation between the ignition ON state and the ignition OFF state.

In detail, as shown in the left view of FIG. 6 illustrating a normal operational state of the cut solenoid 500, the flow state of the current applied to the cut solenoid 500 varies in a phase corresponding to the phase of the ignition ON state and the ignition OFF state.

The center view of FIG. 6 shows the occurrence of disconnection of the cut solenoid related circuit. Particularly, this view shows the case in which, because disconnection of the cut solenoid related circuit occurs during the normal operational state, the supply of current to the cut solenoid 500 is interrupted during the ignition ON state.

If this state is detected, the electronic control unit 1 stores a desired diagnostic trouble code, as described above, thus providing information about the malfunction when vehicle maintenance is performed.

Of course, in this case, the injector 502 cannot perform fuel injection normally.

The right view of FIG. 6 shows a shorted state of the cut solenoid related circuit. Particularly, this view shows the case in which current still flows through the cut solenoid 500 despite the occurrence of the ignition OFF state.

This is the case in which a section A-B in a circuit diagram of FIG. 6 is shorted to a battery side, and a section C-D is shorted to the ground. In this case, because the current continuously flows through the cut solenoid 500, the cut solenoid part 506 of the injector 502 is still open even after the engine is stopped. Thus, there is the likelihood of fuel leakage.

As is apparent from the foregoing, the present invention provides a control circuit for an injector having a cut solenoid for an LPI engine, a control method of the cut solenoid and a diagnostic method thereof, so that fuel is effectively prevented from leaking through an injector to the atmosphere when the LPI engine stops, thus preventing air pollution, and meeting a variety of relevant regulations.

1. A control circuit for injectors having cut solenoids for an LPI (liquefied petroleum gas injection) engine, comprising:
cut solenoids provided in the respective injectors;
a power supply connected to each of the cut solenoids;
an electronic control unit to control the cut solenoids; and
control lines connecting the electronic control unit to the respective cut solenoids.

2. The control circuit as defined in claim 1, wherein each of the injectors comprises an injector part and a cut solenoid part, and the electronic control unit controls the injector parts of the injectors.

3. The control circuit as defined in claim 1, wherein the power supply connected to each of the cut solenoids supplies power to the cut solenoids through a fuel pump relay provided to supply power to a fuel pump.

4. The control circuit as defined in claim 3, wherein the electronic control unit comprises:
a transistor to switch power of each cut solenoid;
a drive circuit to supply a base current to the transistor; and
a diagnostic circuit to compare a power supply state of the cut solenoid to a state of the engine, thus diagnosing a malfunction in a cut solenoid related circuit.

5. A method for controlling a cut solenoid of an injector for an LPI engine, comprising the steps of:
determining whether a vehicle is in an ignition ON state, in which an ignition key is at an ON position or a START position;
supplying power to the cut solenoid provided in the injector when the vehicle is in the ignition ON state, such that a cut solenoid part of the injector is opened;
diagnosing a malfunction of a cut solenoid related circuit through repeating a step of determining whether there is a malfunction of the cut solenoid related circuit, by comparing the ignition ON state with a power supply state of the cut solenoid until the vehicle enters an ignition OFF state from the ignition ON state, and a step of storing a diagnostic trouble code when there is a malfunction of the cut solenoid related circuit; and
interrupting the power of the cut solenoid when the vehicle is in the ignition OFF state, such that the cut solenoid part of the injector is closed.

6. The method as defined in claim 5, further comprising steps of:
turning on a main relay and a fuel pump relay between the step of determining whether the vehicle is in the ignition ON state and the step of supplying the power to the cut solenoid; and
turning off the main relay and the fuel pump relay between the step of detecting a malfunction until the vehicle enters the ignition OFF state and the step of interrupting the power of the cut solenoid.

7. A method for diagnosing a cut solenoid of an injector of an LPI engine, comprising the steps of:
determining whether a current, applied to the cut solenoid provided in the injector, flows in a phase equal to a phase of both an ignition ON state, in which an ignition key is at an ON position or a START position, and an ignition OFF state, in which the ignition key is at other positions;
determining that a cut solenoid related circuit is in a normal state when the phases are equal to each other; and
determining that the cut solenoid related circuit is in a malfunctioning state when the phases are different from each other.

8. A control circuit for injectors having cut solenoids for a liquefied petroleum gas injection engine, comprising:
one or more cut solenoids provided in one or more injectors; and
a power supply connected to each of the cut solenoids.

9. The control circuit of claim 8 further comprising an electronic control unit to control the cut solenoids.

10. The control circuit of claim 9 further comprising one or more control lines connecting the electronic control unit to the one or more cut solenoids.

11. A method for controlling a cut solenoid of an injector for a liquefied petroleum gas injection engine, comprising:
determining whether a vehicle is in an ignition ON state;
supplying power to one or more cut solenoids provided in one or more injectors when the vehicle is in the ignition ON state, such that a cut solenoid part of the injector is opened; and
diagnosing a malfunction of a cut solenoid related circuit through repeating a step of determining whether there is a malfunction of the cut solenoid related circuit, by comparing the ignition ON state with a power supply state of the cut solenoid until the vehicle enters an ignition OFF state from the ignition ON state

12. The method of claim 11 further comprising interrupting the power of the one or more cut solenoids when the vehicle is in the ignition OFF state.

13. The method of claim 12 wherein a diagnostic trouble code is stored when there is a malfunction of the cut solenoid related circuit.

14. A vehicle comprising a control circuit of claim 1.

15. A vehicle comprising a control circuit of claim 8.
